(19) United States
(12) Patent Application Publication
(10) Pub. No.: US 2026/0085253 A1
(43) Pub. Date: Mar. 26, 2026

(54) LILY OF THE VALLEY ODORANT

(71) Applicant: Firmenich SA, Satigny (CH)

(72) Inventors: Fabrice ROBVIEUX, Satigny (CH); Vincent HARRACA, Satigny (CH)

(21) Appl. No.: 19/113,518

(22) PCT Filed: Sep. 29, 2023
(86) PCT No.: PCT/EP23/77016

§ 371 Date: Mar. 20, 2025

(30) Foreign Application Priority Data
Sep. 29, 2022 (EP) 22198660.7
Mar. 14, 2023 (EP) 23161670.7

(51) Int. Cl. C11B 9/00

(52) U.S. Cl. CPC C11B 9/0034

(57) ABSTRACT

Described herein is a composition including 3-(4-isopropyl-2-methylphenyl)propanal and 3-(2-isopropyl-4-methylphenyl)propanal, which are useful perfuming ingredients of the aldehydic, floral type. composition may be part of a perfuming composition or a perfumed consumer product.

### TECHNICAL FIELD

The present invention relates to the field of perfumery. More particularly, it concerns the use as perfuming ingredient or to control arthropod of a composition of matter comprising 3-(4-isopropyl-2-methylphenyl)propanal and 3-(2-isopropyl-4-methylphenyl)propanal, which are useful perfuming ingredients of the aldehydic, floral type. Therefore, following what is mentioned herein, the present invention comprises the invention's composition of matter as part of a perfuming composition or of a perfumed consumer product.

### BACKGROUND OF THE INVENTION

Some of the most sought-after ingredients in the perfumery field are the ones imparting a floral impression and especially a lily of the valley odor. Adding to its value is the observation that this delicate floral odor does not survive even the mildest of extraction methods to yield an essential oil. Said note is very appreciated and used in a multitude of perfumed consumer products. For many decades, a lot of effort has been invested in finding compounds possessing this very complex white floral odor, especially since the use of Lilial® (2-methyl-3-[4-(2-methyl-2-propanyl)phenyl]propanal, trademark from Givaudan-Roure S A, Vernier, Suisse) representing one of the most valuable perfuming ingredients with a lily of the valley and watery connotation, has been limited due to various reasons.

There is a need to develop novel perfuming ingredients conferring a floral odor note being as close as possible to the natural odor of the lily of the valley blossom.

Helvetica Chimica Acta 1996 1095 reports 3-(4-isopropyl-2-methylphenyl)propanal and analogues wherein 3-(4-(tert-butyl)-2-methylphenyl)propanal is reported as a valuable odorant imparting a Lilial®-type lily-of-the-valley odor, with a slight aniseed undertone.

The present invention provides a novel composition of matter comprising 3-(4-isopropyl-2-methylphenyl)propanal and 3-(2-isopropyl-4-methylphenyl)propanal providing a lily of the valley note very appreciated in perfumery. The prior art does not anticipate that the present composition of matter provides such an increase in performance and odour character.

### DESCRIPTION OF THE INVENTION

A surprising synergic effect has been discovered between 3-(4-isopropyl-2-methylphenyl)propanal and 3-(2-isopropyl-4-methylphenyl)propanal leading to the invention composition of matter possessing a aldehydic/floral note combined with a green note.

So, a first object of the present invention is a composition of matter comprising 3-(4-isopropyl-2-methylphenyl)propanal and 3-(2-isopropyl-4-methylphenyl)propanal.

Said composition of matter can be used as perfuming ingredient, for instance to impart odor notes of the aldehydic, floral type.

According to any embodiments of the invention, the invention's composition of matter may comprise at least 75% w/w of 3-(4-isopropyl-2-methylphenyl)propanal, particularly, 80% w/w of 3-(4-isopropyl-2-methylphenyl)propanal, particularly, 85% w/w of 3-(4-isopropyl-2-methylphenyl)propanal, particularly, 87% w/w of 3-(4-isopropyl-2-methylphenyl)propanal, particularly, 90%/w/w of 3-(4-isopropyl-2-methylphenyl)propanal, particularly, 95% w/w of 3-(4-isopropyl-2-methylphenyl)propanal, particularly, 98% w/w of 3-(4-isopropyl-2-methylphenyl)propanal, particularly, 99%/w/w of 3-(4-isopropyl-2-methylphenyl)propanal, even more particularly, 99.5% w/w of 3-(4-isopropyl-2-methylphenyl)propanal, the percentage being relative to the total weight of the composition of matter.

According to any embodiments of the invention, the invention's composition of matter may comprise at mot 25% w/w of 3-(2-isopropyl-4-methylphenyl)propanal, particularly, 20% w/w of 3-(4-isopropyl-2-methylphenyl)propanal, particularly, 15% w/w of 3-(4-isopropyl-2-methylphenyl)propanal, particularly, 10% w/w of 3-(2-isopropyl-4-methylphenyl)propanal, particularly, 5% w/w of 3-(2-isopropyl-4-methylphenyl)propanal, particularly, 2% w/w of 3-(2-isopropyl-4-methylphenyl)propanal, particularly, 1% w/w of 3-(2-isopropyl-4-methylphenyl)propanal, even more particularly, 0.5% w/w of 3-(2-isopropyl-4-methylphenyl)propanal, the percentage being relative to the total weight of the composition of matter.

According to any embodiments of the invention, the invention's composition of matter may comprise 75% to 99.5% w/w of 3-(4-isopropyl-2-methylphenyl)propanal and 0.5% to 25% w/w of 3-(2-isopropyl-4-methylphenyl)propanal, the percentage being relative to the total weight of the composition of matter. Particularly, the invention's composition of matter may comprise 80% to 99% w/w of 3-(4-isopropyl-2-methylphenyl)propanal and 1% to 20% w/w of 3-(2-isopropyl-4-methylphenyl)propanal, the percentage being relative to the total weight of the composition of matter. Particularly, the invention's composition of matter may comprise 85% to 95% w/w of 3-(4-isopropyl-2-methylphenyl)propanal and 3% to 15% w/w of 3-(2-isopropyl-4-methylphenyl)propanal, the percentage being relative to the total weight of the composition of matter. Even more particularly, the invention's composition of matter may comprise 88% to 95% w/w of 3-(4-isopropyl-2-methylphenyl)propanal and 3% to 8% w/w of 3-(2-isopropyl-4-methylphenyl)propanal, the percentage being relative to the total weight of the composition of matter.

According to any embodiments of the invention, the ratio between 3-(4-isopropyl-2-methylphenyl)propanal and 3-(2-isopropyl-4-methylphenyl)propanal is comprised between 85:15 and 99.5:05, even between 90:10 and 99:1, even between 92:8 and 98:2, even between 94:6 and 98:2.

According to any embodiments of the invention, the invention's composition of matter may further comprise 3-(5-isopropyl-2-methylphenyl)propanal. Particularly, the invention's composition of matter may comprise at most 10% of 3-(5-isopropyl-2-methylphenyl)propanal, particularly, at most 8% of 3-(5-isopropyl-2-methylphenyl)propanal, particularly, at most 5% of 3-(5-isopropyl-2-methylphenyl)propanal, particularly, at most 3% of 3-(5-isopropyl-2-methylphenyl)propanal, particularly, at most 2% of 3-(5-isopropyl-2-methylphenyl)propanal, even more particularly, at most 1% of 3-(5-isopropyl-2-methylphenyl)propanal, the percentage being relative to the total weight of the composition of matter.

As specific examples of the invention's composition of matter, one may cite, as non-limiting example, a composition of matter comprising 93% w/w of 3-(4-isopropyl-2-methylphenyl)propanal and 7% w/w of 3-(2-isopropyl-4-methylphenyl)propanal, the percentage being relative to the total weight of the composition of matter. 3-(2-isopropyl-4-methylphenyl)propanal is a novel compound and present a number of advantages as explained above. Therefore, another object of the present invention is, as compound 3-(2-isopropyl-4-methylphenyl)propanal. 3-(2-isopropyl-4-methylphenyl)propanal can be used as perfuming ingredient, for instance to impart odor notes of the aldehydic, floral type.

As mentioned above, the invention concerns the use of 3-(2-isopropyl-4-methylphenyl)propanal or 3-(5-isopropyl-2-methylphenyl)propanal or of the invention's compositions of matter as a perfuming ingredient. In other words, it concerns a method or a process to confer, enhance, improve or modify the odor properties of a perfuming composition or of a perfumed article or of a surface, which method comprises adding to said composition or article an effective amount of 3-(2-isopropyl-4-methylphenyl)propanal or 3-(5-isopropyl-2-methylphenyl)propanal or of the invention's compositions of matter, e.g. to impart its typical note. Understood that the final hedonic effect may depend on the precise dosage and on the organoleptic properties of 3-(2-isopropyl-4-methylphenyl)propanal or 3-(5-isopropyl-2-methylphenyl)propanal or of the invention's composition of matter, but anyway the addition of 3-(2-isopropyl-4-methylphenyl)propanal or 3-(5-isopropyl-2-methylphenyl)propanal or of the invention's composition of matter, will impart to the final product its typical touch in the form of a note, touch or aspect depending on the dosage.

By “use of 3-(2-isopropyl-4-methylphenyl)propanal or 3-(5-isopropyl-2-methylphenyl)propanal or of the invention's composition of matter” it has to be understood here also the use of any composition containing 3-(2-isopropyl-4-methylphenyl)propanal or 3-(5-isopropyl-2-methylphenyl)propanal or the invention's composition of matter and which can be advantageously employed in the perfumery industry.

Said compositions, which in fact can be advantageously employed as perfuming ingredients, are also an object of the present invention.

Therefore, another object of the present invention is a perfuming composition comprising:
i) as a perfuming ingredient, 3-(2-isopropyl-4-methylphenyl)propanal or 3-(5-isopropyl-2-methylphenyl)propanal or at least one invention's composition of matter as defined above;
ii) at least one ingredient selected from the group consisting of a perfumery carrier and a perfumery base; and
iii) optionally at least one perfumery adjuvant.

By “perfumery carrier” it is meant here a material which is practically neutral from a perfumery point of view, i.e. that does not significantly alter the organoleptic properties of perfuming ingredients. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly used in perfumery cannot be exhaustive. However, one can cite as non-limiting examples, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, Abalyn® (rosin resins, available from Eastman), benzyl benzoate, benzyl alcohol, 2-(2-ethoxyethoxy)-1-ethanol, tri-ethyl citrate or mixtures thereof, which are the most commonly used or also naturally derived solvents like glycerol or various vegetable oils such as palm oil, sunflower oil or linseed oil. For the compositions which comprise both a perfumery carrier and a perfumery base, other suitable perfumery carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company), or hydrogenated castors oils such as those known under the trademark Cremophor® RH 40 (origin: BASF).

Solid carrier is meant to designate a material to which the perfuming composition or some element of the perfuming composition can be chemically or physically bound. In general such solid carriers are employed either to stabilize the composition, or to control the rate of evaporation of the compositions or of some ingredients. Solid carriers are of current use in the art and a person skilled in the art knows how to reach the desired effect. However by way of non-limiting examples of solid carriers, one may cite absorbing gums or polymers or inorganic materials, such as porous polymers, cyclodextrines, dextrines, maltodextrines wood based materials, organic or inorganic gels, clays, gypsum talc or zeolites.

As other non-limiting examples of solid carriers, one may cite encapsulating materials. Examples of such materials may comprise wall-forming and plasticizing materials, such as glucose syrups, natural or modified starches, hydrocolloids, cellulose derivatives, polyvinyl acetates, polyvinylalcohols, proteins or pectins, plant gums such as acacia gum (Gum Arabic), urea, sodium chloride, sodium sulphate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, carbohydrates, saccharides such as sucrose, mono-, di-, tri- and polysaccharides and derivatives such as chitosan, starch, cellulose, carboxymethyl methylcellulose, methylcellulose, hydroxyethyl cellulose, ethyl cellulose, propyl cellulose, polyols/sugar alcohols such as sorbitol, maltitol, xylitol, erythritol, and isomalt, polyethylene glycol (PEG), polyvinyl pyrrolidin (PVP), polyvinyl alcohol, acrylamides, acrylates, polyacrylic acid and related, maleic anhydride copolymers, amine-functional polymers, vinyl ethers, styrenes, polystyrenesulfonates, vinyl acids, ethylene glycol-propylene glycol block copolymers, vegetable gums, gum acacia, pectins, xanthanes, alginates, carragenans, citric acid or any water soluble solid acid, fatty alcohols or fatty acids and mixtures thereof, or yet the materials cited in reference texts such as H. Scherz, Hydrokolloide: Stabilisatoren, Dickungs-und Geliermittel in Lebensmitteln, Band 2 der Schriftenreihe Lebensmittelchemie, Lebensmittelqualität, Behr's Verlag GmbH & Co., Hamburg, 1996. The encapsulation is a well-known process to a person skilled in the art, and may be performed, for instance, by using techniques such as spray-drying, agglomeration or yet extrusion; or consists of a coating encapsulation, including coacervation and complex coacervation techniques.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluril, melamine, methylol melamine, methylated methylol melamine, guanazole and the like, as well as mixtures thereof. Alternatively one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Other resins are the ones produced by the polycondensation of a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate are preferred.

Some of the seminal literature related to the encapsulation of perfumes by polycondensation of amino resins, namely melamine based resins with aldehydes includes articles such as those published by K. Dietrich et al. Acta Polymerica, 1989, vol. 40, pages 243, 325 and 683, as well as 1990, Vol. 41, page 91. Such articles already describe the various parameters affecting the preparation of such core-shell microcapsules following prior art methods that are also further detailed and exemplified in the patent literature. US 4′396′670, to the Wiggins Teape Group Limited is a pertinent early example of the latter. Since then, many other authors have enriched the literature in this field and it would be impossible to cover all published developments here, but the general knowledge in encapsulation technology is very significant. More recent publications of pertinence, which disclose suitable uses of such microcapsules, are represented for example by the article of K. Bruyninckx and M. Dusselier, ACS Sustainable Chemistry & Engineering, 2019, vol. 7, pages 8041-8054.

By “perfumery base” what is meant here is a composition comprising at least one perfuming co-ingredient.

Said perfuming co-ingredient is not 3-(2-isopropyl-4-methylphenyl)propanal or 3-(5-isopropyl-2-methylphenyl)propanal or the invention's composition of matter. Moreover, by “perfuming co-ingredient” it is meant here a compound, which is used in a perfuming preparation or a composition to impart a hedonic effect; i.e. used for the primary purpose of conferring or modulating an odor. In other words such a co-ingredient, to be considered as being a perfuming one, must be recognized by a person skilled in the art as being able to impart or modify in a positive or pleasant way the odor of a composition, and not just as having an odor. The perfuming ingredient may impart an additional benefit beyond that of modifying or imparting an odor, such as long-lasting, blooming, malodour counteraction, antimicrobial effect, antiviral effect, microbial stability, or pest control.

The nature and type of the perfuming co-ingredients present in the base do not warrant a more detailed description here, which in any case would not be exhaustive, the skilled person being able to select them on the basis of his general knowledge and according to the intended use or application and the desired organoleptic effect. In general terms, these perfuming co-ingredients belong to chemical classes as varied as alcohols, lactones, aldehydes, ketones, esters, ethers, acetates, nitriles, terpenoids, nitrogenous or sulphurous heterocyclic compounds and essential oils, and said perfuming co-ingredients can be of natural or synthetic origin.

In particular one may cite perfuming co-ingredients which are commonly used in perfume formulations, such as:
Aldehydic ingredients: decanal, dodecanal, 2-methyl-undecanal, 10-undecenal, octanal, nonanal and/or nonenal;
Aromatic-herbal ingredients: eucalyptus oil, camphor, eucalyptol, 5-methyltricyclo[6.2.1.0^{2,7}]undecan-4-one, 1-methoxy-3-hexanethiol, 2-ethyl-4,4-dimethyl-1,3-oxathiane, 2,2,7/8,9/10-Tetramethylspiro[5.5]undec-8-en-1-one, menthol and/or alpha-pinene;
Balsamic ingredients: coumarin, ethylvanillin and/or vanillin;
Citrus ingredients: dihydromyrcenol, citral, orange oil, linalyl acetate, citronellyl nitrile, orange terpenes, limonene, 1-p-menthen-8-yl acetate and/or 1,4(8)-p-menthadiene;
Floral ingredients: methyl dihydrojasmonate, linalool, citronellol, phenylethanol, 3-(4-tert-butylphenyl)-2-methylpropanal, hexylcinnamic aldehyde, benzyl acetate, benzyl salicylate, tetrahydro-2-isobutyl-4-methyl-4(2H)-pyranol, beta ionone, methyl 2-(methylamino)benzoate, (E)-3-methyl-4-(2,6,6-trimethyl-2-cyclohexen-1-yl)-3-buten-2-one, (1E)-1-(2,6,6-trimethyl-2-cyclohexen-1-yl)-1-penten-3-one, 1-(2,6,6-trimethyl-1,3-cyclohexadien-1-yl)-2-buten-1-one,(2E)-1-(2,6,6-trimethyl-2-cyclohexen-1-yl)-2-buten-1-one, (2E)-1-[2,6,6-trimethyl-3-cyclohexen-1-yl]-2-buten-1-one, (2E)-1-(2,6,6-trimethyl-1-cyclohexen-1-yl)-2-buten-1-one, 2,5-dimethyl-2-indanmethanol, 2,6,6-trimethyl-3-cyclohexene-1-carboxylate, 3-(4,4-dimethyl-1-cyclohexen-1-yl)propanal, 3-(3,3/1,1-dimethyl-5-indanyl)propanal, hexyl salicylate, 3,7-dimethyl-1,6-nonadien-3-ol, 3-(4-isopropylphenyl)-2-methylpropanal, verdyl acetate, geraniol, p-menth-1-en-8-ol, 4-(1,1-dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, verdyl proprionate, geranyl acetate, tetrahydro linalool, cis-7-p-menthanol, propyl(S)-2-(1,1-dimethylpropoxy)propanoate, 2-methoxynaphthalene, 2,2,2-trichloro-1-phenylethyl acetate, 4/3-(4-hydroxy-4-methylpentyl)-3-cyclohexene-1-carbaldehyde, amylcinnamic aldehyde, 8-decen-5-olide, 4-phenyl-2-butanone, isononyle acetate, 4-(1,1-dimethylethyl)-1-cyclohexyl acetate, verdyl isobutyrate and/or mixture of methylionones isomers;
Fruity ingredients: gamma-undecalactone, 2,2,5-trimethyl-5-pentylcyclopentanone, 2-methyl-4-propyl-1,3-oxathiane, 4-decanolide, ethyl 2-methyl-pentanoate, hexyl acetate, ethyl 2-methylbutanoate, gamma-nonalactone, allyl heptanoate, 2-phenoxyethyl isobutyrate, ethyl 2-methyl-1,3-dioxolane-2-acetate, diethyl 1,4-cyclohexanedicarboxylate, 3-methyl-2-hexen-1-yl acetate, 1-[3,3-dimethylcyclohexyl]ethyl[3-ethyl-2-oxiranyl]acetate and/or diethyl 1,4-cyclohexane dicarboxylate;
Green ingredients: 2-methyl-3-hexanone (E)-oxime, 2,4-dimethyl-3-cyclohexene-1-carbaldehyde, 2-tert-butyl-1-cyclohexyl acetate, styrallyl acetate, allyl(2-methylbutoxy)acetate, 4-methyl-3-decen-5-ol, diphenyl ether, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, (Z)-4-cyclopentadecen-1-one, 3-methylcyclopentadecanone, 1-oxa-12-cyclohexadecen-2-one, 1-oxa-13-cyclohexadecen-2-one, (9Z)-9-cycloheptadecen-1-one, 2-{(1S)-1-[(1R)-3,3-dimethylcyclohexyl]ethoxy}-2-oxoethyl propionate, 3-methyl-5-cyclopentadecen-1-one, 4,6,6,7,8,8-hexamethyl-1,3,4,6,7,8-hexahydrocyclopenta[g]isochromene, (1S,1′R)-2-[1-(3′,3‘-dimethyl-1’-cyclohexyl)ethoxy]-2-methylpropyl propanoate, oxacyclohexadecan-2-oneand/or (1S,1′R)-[1-(3′,3′-dimethyl-1′-cyclohexyl)ethoxycarbonyl]methyl propanoate;
Woody ingredients: 1-[(1RS,6SR)-2,2,6-trimethylcyclohexyl]-3-hexanol, 3,3-dimethyl-5-[(1R)-2,2,3-trimethyl-3-cyclopenten-1-yl]-4-penten-2-ol, 3,4′-dimethylspiro[oxirane-2,9′-tricyclo[6.2.1.0^{2,7}]undec[4]ene, (1-ethoxyethoxy)cyclododecane, 2,2,9,11-tetramethylspiro[5.5]undec-8-en-1-yl acetate, 1-(octahydro-2,3,8,8-tetramethyl-2-naphtalenyl)-1-ethanone, patchouli oil, terpenes fractions of patchouli oil, Clearwood® (Origin: Firmenich S A), (1′R,E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl)ethan-1-one and/orisobornyl acetate;
Other ingredients (e.g. amber, powdery spicy or watery): dodecahydro-3a,6,6,9a-tetramethyl-naphtho[2,1-b]furan and any of its stereoisomers, heliotropin, anisic aldehyde, eugenol, cinnamic aldehyde, clove oil, 3-(1,3-benzodioxol-5-yl)-2-methylpropanal, 7-methyl-2H-1,5-benzodioxepin-3(4H)-one, 2,5,5-trimethyl-1,2,3,4,4a,5,6,7-octahydro-2-naphthalenol, 1-phenylvinyl acetate, 6-methyl-7-oxa-1-thia-4-azaspiro[4.4]nonane and/or 3-(3-isopropyl-1-phenyl)butanal.

A perfumery base according to the invention may not be limited to the above-mentioned perfuming co-ingredients, and many other of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery. It is also understood that said co-ingredients may also be compounds known to release in a controlled manner various types of perfuming compounds also known as properfume or profragrance. Non-limiting examples of suitable properfume may include 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone, trans-3-(dodecylthio)-1-(2,6,6-trimethyl-3-cyclohexen-1-yl)-1-butanone, 3-(dodecylsulfonyl)-1-(2,6,6-trimethylcyclohex-3-en-1-yl)butan-1-one, a linear polysiloxane co-polymer of (3-mercaptopropylxmethyl)dimethoxysilane, 1-[6-ethyl-2,6-dimethyl-3-cyclohexen-1-yl]-2-buten-1-one, 2-(dodecylthio)octan-4-one, 2-(dodecylsulfonyl)octan-4-one, 4-oxooctan-2-yl dodecanoate, 2-phenylethyl oxo(phenyl)acetate, 3,7-dimethylocta-2,6-dien-1-yl oxo(phenyl)acetate, (Z)-hex-3-en-1-yl oxo(phenyl)acetate, 3,7-dimethyl-2,6-octadien-1-yl hexadecanoate, bis(3,7-dimethylocta-2,6-dien-1-yl) succinate, (2E,6Z)-2,6-nonadienyl hexadecanoate, (2E,6Z)-2,6-nonadien-1-yl tetradecanoate, (2E,6Z)-2,6-nonadien-1-yl dodecanoate, (2-((2-methylundec-1-en-1-yl)oxy)ethyl)benzene, 1-methoxy-4-(3-methyl-4-phenethoxybut-3-en-1-yl)benzene, (3-methyl-4-phenethoxybut-3-en-1-yl)benzene, 1-(((Z)-hex-3-en-1-yl)oxy)-2-methylundec-1-ene, (2-((2-methylundec-1-en-1-yl)oxy)ethoxy)benzene, 2-methyl-1-(octan-3-yloxy)undec-1-ene, 1-methoxy-4-(1-phenethoxyprop-1-en-2-yl)benzene, 1-methyl-4-(1-phenethoxyprop-1-en-2-yl)benzene, 2-(1-phenethoxyprop-1-en-2-yl)naphthalene, (2-phenethoxyvinyl)benzene, 2-(1-((3,7-dimethyloct-6-en-1-yl)oxy)prop-1-en-2-yl)naphthalene, (2-((2-pentylcyclopentylidene)methoxy)ethyl)benzene, 4-allyl-2-methoxy-1-((2-methoxy-2-phenylvinyl)oxy)benzene, (2-((2-heptylcyclopentylidene)methoxy)ethyl)benzene, 1-methoxy-4-(1-phenethoxyprop-1-en-2-yl)benzene, (2-((2-methyl-4-(2,6,6-trimethylcyclohex-1-en-1-yl)but-1-en-1-yl)oxy)ethyl)benzene, 1-methoxy-4-(2-methyl-3-phenethoxyallyl)benzene, (2-((2-isopropyl-5-methylcyclohexylidene)methoxy)ethyl)benzene, 1-isopropyl-4-methyl-2-((2-pentylcyclopentylidene)methoxy)benzene, 2-methoxy-1-((2-pentylcyclopentylidene)methoxy)-4-propylbenzene, 2-ethoxy-1-((2-methoxy-2-phenylvinyl)oxy)-4-methylbenzene, 3-methoxy-4-((2-methoxy-2-phenylvinyl)oxy)benzaldehyde, 1-isopropyl-2-((2-methoxy-2-phenylvinyl)oxy)-4-methylbenzene, 4-((2-(hexyloxy)-2-phenylvinyl)oxy)-3-methoxybenzaldehyde or a mixture thereof.

By “perfumery adjuvant”, it is meant here an ingredient capable of imparting additional added benefit such as a color, a particular light resistance, chemical stability, etc. A detailed description of the nature and type of adjuvant commonly used in perfuming composition cannot be exhaustive, but it has to be mentioned that said ingredients are well known to a person skilled in the art. One may cite as specific non-limiting examples the following: viscosity agents (e.g. surfactants, thickeners, gelling and/or rheology modifiers), stabilizing agents (e.g. preservatives, antioxidant, heat/light and or buffers or chelating agents, such as BHT), coloring agents (e.g. dyes and/or pigments), preservatives (e.g. antibacterial or antimicrobial or antifungal or anti irritant agents), abrasives, skin cooling agents, fixatives, insect repellants, ointments, vitamins and mixtures thereof. By “fixative” also called “modulator”, it is understood here an agent having the capacity to affect the manner in which the odour, and in particular the evaporation rate and intensity, of the compositions incorporating said modulator can be perceived by an observer or user thereof, over time, as compared to the same perception in the absence of the modulator. In particular, the modulator allows prolonging the time during which their fragrance is perceived. Non-limiting examples of suitable modulators may include methyl glucoside polyol; ethyl glucoside polyol; propyl glucoside polyol; isocetyl alcohol; PPG-3 myristyl ether; neopentyl glycol diethylhexanoate; sucrose laurate; sucrose dilaurate, sucrose myristate, sucrose palmitate, sucrose stearate, sucrose distearate, sucrose tristearate, hyaluronic acid disaccharide sodium salt, sodium hyaluronate, propylene glycol propyl ether; dicetyl ether; polyglycerin-4 ethers; isoceteth-5; isoceteth-7, isoceteth-10; isoceteth-12; isoceteth-15; isoceteth-20; isoceteth-25; isoceteth-30; disodium lauroamphodipropionate; hexaethylene glycol monododecyl ether; and their mixtures; neopentyl glycol diisononanoate; cetearyl ethylhexanoate; panthenol ethyl ether, DL-panthenol, N-hexadecyl n-nonanoate, noctadecyl n-nonanoate, a profragrance, cyclodextrin, an encapsulation, and a combination thereof. At most 20% by weight, based on the total weight of the perfuming composition, of the modulator may be incorporated into the perfumed consumer product.

It is understood that a person skilled in the art is perfectly able to design optimal formulations for the desired effect by admixing the above mentioned components of a perfuming composition, simply by applying the standard knowledge of the art as well as by trial and error methodologies.

An invention's composition consisting of at least 3-(2-isopropyl-4-methylphenyl)propanal or at least 3-(5-isopropyl-2-methylphenyl)propanal or at least one invention's composition of matter and at least one perfumery carrier consists of a particular embodiment of the invention as well as a perfuming composition comprising at least 3-(2-isopropyl-4-methylphenyl)propanal or at least 3-(5-isopropyl-2-methylphenyl)propanal or at least one invention's composition of matter, at least one perfumery carrier, at least one perfumery base, and optionally at least one perfumery adjuvant.

According to a particular embodiment, the perfuming composition is in the form of a microcapsule, preferably a microcapsule slurry, comprising at least 3-(2-isopropyl-4-methylphenyl)propanal or at least 3-(5-isopropyl-2-methylphenyl)propanal or at least one invention's composition of matter. In one embodiment, 3-(2-isopropyl-4-methylphenyl)propanal or 3-(5-isopropyl-2-methylphenyl)propanal or the invention's composition of matter is encapsulated in a core-shell microcapsule wherein 3-(2-isopropyl-4-methylphenyl)propanal or 3-(5-isopropyl-2-methylphenyl)propanal or the invention's composition of matter is contained in the core surrounded by the shell. In one embodiment, the shell of the microcapsule protects 3-(2-isopropyl-4-methylphenyl)propanal or 3-(5-isopropyl-2-methylphenyl)propanal or the invention's composition of matter from the environment. The shell is made of material which is able to release 3-(2-isopropyl-4-methylphenyl)propanal or 3-(5-isopropyl-2-methylphenyl)propanal or the invention's composition of matter. In one embodiment, the shell is made of material which is able to release 3-(2-isopropyl-4-methylphenyl)propanal or 3-(5-isopropyl-2-methylphenyl)propanal or the invention's composition of matter upon breakage of the shell and/or by diffusion through the shell. A person skilled in the art is well aware of processes to prepare said microcapsules. The core of the core-shell microcapsule, in addition to 3-(2-isopropyl-4-methylphenyl)propanal or 3-(5-isopropyl-2-methylphenyl)propanal or the invention's composition of matter, may further comprise at least one liquid carrier as defined above and/or at least one perfuming co-ingredient as defined above. The core-shell microcapsules or the core-shell microcapsule slurry comprising at least 3-(2-isopropyl-4-methylphenyl)propanal or 3-(5-isopropyl-2-methylphenyl)propanal or at least one invention's composition of matter may be dispersed into at least one liquid carrier as defined above. Said liquid carrier may further comprise 3-(2-isopropyl-4-methylphenyl)propanal or 3-(5-isopropyl-2-methylphenyl)propanal or the invention's composition of matter and/or at least one perfuming co-ingredient as defined above.

According to a particular embodiment, the shell of the microcapsule comprises a material selected from the group consisting of polyurea, polyurethane, polyamide, polyester, poly(meth)acrylate (i.e. polyacrylate and/or polymethacrylate), polysiloxane, polycarbonate, polysulfonamide, polymers of urea and formaldehyde, melamine and formaldehyde, melamine and urea, or melamine and glyoxal and mixtures thereof. The shell can also be hybrid, namely organic-inorganic such as a hybrid shell composed of at least two types of inorganic particles that are cross-linked, or yet a shell resulting from the hydrolysis and condensation reaction of a polyalkoxysilane macro-monomeric composition.

According to a particular embodiment, the core-shell microcapsule(s) can be also derived by using different or more than one encapsulation method.

In a preferred embodiment, the shell of the microcapsules may be, each independently, selected from the group of aminoplast, polyamide, polyester, polyurea and polyurethane shells and mixtures thereof.

In a particular embodiment, the shell of the microcapsules comprises an aminoplast copolymer, such as melamine-formaldehyde or urea-formaldehyde or cross-linked melamine formaldehyde or melamine glyoxal.

In a particular embodiment, the shell of the microcapsules is polyurea-based made from, for example but not limited to, isocyanate-based monomers and amine-containing crosslinkers such as guanidine carbonate and/or guanazole. Certain polyurea microcapsules comprise a polyurea wall which is the reaction product of the polymerization between at least one polyisocyanate comprising at least two isocyanate functional groups and at least one reactant selected from the group consisting of an amine (for example a water-soluble guanidine salt and guanidine); a colloidal stabilizer or emulsifier; and an encapsulated perfume. However, the use of an amine can be omitted.

In a particular embodiment, the colloidal stabilizer includes an aqueous solution of between 0.1% and 0.4% of polyvinyl alcohol, between 0.6% and 1% of a cationic copolymer of vinylpyrrolidone and of a quaternized vinylimidazole (all percentages being defined by weight relative to the total weight of the colloidal stabilizer). In a particular embodiment, the emulsifier is an anionic or amphiphilic biopolymer, which may be for example chosen from the group consisting of gum Arabic, soy protein, gelatin, sodium caseinate and mixtures thereof.

In a particular embodiment, the shell of the microcapsules is polyurethane-based made from, for example but not limited to, polyisocyanate and polyols, polyamide, polyester, etc.

In a particular embodiment, the microcapsules have a polymeric shell resulting from complex coacervation wherein the shell is possibly cross-linked.

In a particular embodiment of the core-shell microcapsules, the core-shell microcapsules comprise an oil-based core comprising a hydrophobic active, preferably at least 3-(2-isopropyl-4-methylphenyl)propanal or 3-(5-isopropyl-2-methylphenyl)propanal or at least one invention's composition of matter, and a composite shell comprising a first material and a second material, wherein the first material and the second material are different, the first material is a coacervate, the second material is a polymeric material.

In a particular embodiment, the weight ratio between the first material and the second material is comprised between 50:50 and 99.9:0.1.

In a particular embodiment, the coacervate comprises a first polyelectrolyte, preferably selected among proteins (such as gelatin), polypeptides or polysaccharides (such as chitosan), most preferably gelatin, and a second polyelectrolyte, preferably alginate salts, cellulose derivatives, guar gum, pectinate salts, carrageenan, polyacrylic and methacrylic acid or xanthan gum, or yet plant gums such as acacia gum (Gum Arabic), most preferably Gum Arabic.

The first coacervate material can be hardened chemically using a suitable cross-linker such as glutaraldehyde, glyoxal, formaldehyde, tannic acid or genipin or can be hardened enzymatically using an enzyme such as transglutaminase.

The second polymeric material can be selected from the group consisting of polyurea, polyurethane, polyamide, polyester, polyacrylate, polysiloxane, polycarbonate, polysulfonamide, polymers of urea and formaldehyde, melamine and formaldehyde, melamine and urea, or melamine and glyoxal and mixtures thereof, preferably polyurea and/or polyurethane. The second material is preferably present in an amount less than 3 wt. %, preferably less than 1 wt. % based on the total weight of the microcapsule slurry.

The preparation of an aqueous dispersion/slurry of core-shell microcapsules is well known by a skilled person in the art. In a particular embodiment, the microcapsule wall material may comprise any suitable resin and especially including melamine, glyoxal, polyurea, polyurethane, polyamide, polyester, etc. Suitable resins include the reaction product of an aldehyde and an amine, suitable aldehydes include, formaldehyde and glyoxal. Suitable amines include melamine, urea, benzoguanamine, glycoluril, and mixtures thereof. Suitable melamines include, methylol melamine, methylated methylol melamine, imino melamine and mixtures thereof. Suitable urea include, dimethylol urea, methylated dimethylol urea, urea-resorcinol, and mixtures thereof. Suitable materials for making may be obtained from one or more of the following companies Solutia Inc. (St Louis, Missouri U.S.A.), Cytec Industries (West Paterson, New Jersey U.S.A.), Sigma-Aldrich (St. Louis, Missouri U.S.A.).

In a particular embodiment of the core-shell microcapsules, the core-shell microcapsules comprise
an oil-based core comprising a hydrophobic active, preferably comprising 3-(2-isopropyl-4-methylphenyl)propanal or 3-(5-isopropyl-2-methylphenyl)propanal or at least one of the invention's composition of matter,
optionally an inner shell made of a polymerized polyfunctional monomer;
a biopolymer shell comprising a protein, wherein at least one protein is cross-linked.

According to a particular embodiment, the protein is chosen from the group consisting of milk proteins, caseinate salts such as sodium caseinate or calcium caseinate, casein, whey protein, hydrolyzed proteins, gelatins, gluten, pea protein, soy protein, silk protein and mixtures thereof, preferably sodium caseinate, most preferably sodium caseinate.

According to a particular embodiment, the protein comprises sodium caseinate and a globular protein, preferably chosen from the group consisting of whey protein, beta-lactoglobulin, ovalbumine, bovine serum albumin, vegetable proteins, and mixtures thereof.

The protein is preferably a mixture of sodium caseinate and whey protein.

According to a particular embodiment, the biopolymer shell comprises a crosslinked protein chosen from the group consisting of sodium caseinate and/or whey protein.

According to a particular embodiment, the microcapsule slurry comprises at least one microcapsule made of:
an oil-based core comprising the hydrophobic active, preferably comprising 3-(2-isopropyl-4-methylphenyl)propanal or 3-(5-isopropyl-2-methylphenyl)propanal or at least one of the invention's composition of matter;
an inner shell made of a polymerized polyfunctional monomer; preferably a polyisocyanate having at least two isocyanate functional groups;
a biopolymer shell comprising a protein, wherein at least one protein is cross-linked; wherein the protein contains preferably a mixture comprising sodium caseinate and a globular protein, preferably whey protein;
optionally at least an outer mineral layer.

According to an embodiment, sodium caseinate and/or whey protein is (are) cross-linked protein(s).

The weight ratio between sodium caseinate and whey protein is preferably comprised between 0.01 and 100, preferably between 0.1 and 10, more preferably between 0.2 and 5.

In a particular embodiment, the microcapsule is a one-shell aminoplast core-shell microcapsule obtainable by a process comprising the steps of:
1) admixing a perfume oil with at least a polyisocyanate having at least two isocyanate functional groups to form an oil phase;
2) dispersing or dissolving into water an aminoplast resin and optionally a stabilizer to form a water phase;
3) preparing an oil-in-water dispersion, wherein the mean droplet size is comprised between 1 and 100 microns, by admixing the oil phase and the water phase;
4) performing a curing step to form the wall of said microcapsule; and
5) optionally drying the final dispersion to obtain the dried core-shell microcapsule.

In a particular embodiment, the core-shell microcapsule is a formaldehyde-free capsule. A typical process for the preparation of an aminoplast formaldehyde-free microcapsule slurry comprises the steps of
1) preparing an oligomeric composition comprising the reaction product of, or obtainable by reacting together:
   a. a polyamine component in the form of melamine or of a mixture of melamine and at least one C₁-C₄ compound comprising two NH₂ functional groups;
   b. an aldehyde component in the form of a mixture of glyoxal, a C₄₋₆ 2,2-dialkoxy-ethanal and optionally a glyoxalate, said mixture having a molar ratio glyoxal/C₄₋₆ 2,2-dialkoxy-ethanal comprised between 1/1 and 10/1; and c. a protic acid catalyst;
2) preparing an oil-in-water dispersion, wherein the droplet size is comprised between 1 and 600 microns, and comprising:
   a. an oil;
   b. a water medium;
   c. at least an oligomeric composition as obtained in step 1;
   d. at least a cross-linker selected amongst:
      i. C₄-C₁₂ aromatic or aliphatic di- or tri-isocyanates and their biurets, triurets, trimmers, trimethylol propane-adduct and mixtures thereof, and/or
      ii. a di- or tri-oxiran compound of formula:

Q-(oxiran-2-ylmethyl)ₘ
wherein m is 2 or 3 and Q represents a C₂-C₆ group optionally comprising from 2 to 6 nitrogen and/or oxygen atoms;
e. optionally a C₁-C₄ compounds comprising two NH₂ functional groups;
3) heating the dispersion; and
4) cooling the dispersion.

The above process is described in more detail in WO 2013/068255.

In a particular embodiment of the core-shell microcapsules, the core-shell microcapsule is a polyamide core-shell microcapsule comprising:
an oil based core comprising an hydrophobic active, preferably comprising 3-(2-isopropyl-4-methylphenyl)propanal or 3-(5-isopropyl-2-methylphenyl)propanal or at least one of the invention's composition of matter, and
a polyamide shell comprising or being obtainable from:
   an acyl chloride,
   a first amino compound, and
   a second amino compound.

According to a particular embodiment, the polyamide core-shell microcapsule comprises:
an oil based core comprising an hydrophobic active, preferably comprising 3-(2-isopropyl-4-methylphenyl)propanal or 3-(5-isopropyl-2-methylphenyl)propanal or at least one of the invention's composition of matter, and
a polyamide shell comprising or being obtainable from:
   an acyl chloride, preferably in an amount comprised between 5 and 98%, preferably between 20 and 98%, more preferably between 30 and 85% w/w;
   a first amino compound, preferably in an amount comprised between 1% and 50% w/w, preferably between 7 and 40% w/w;
   a second amino compound, preferably in an amount comprised between 1% and 50% w/w, preferably between 2 and 25% w/w;
   a stabilizer, preferably a biopolymer, preferably in an amount comprised between 0 and 90%, preferably between 0.1 and 75%, more preferably between 1 and 70%.

According to a particular embodiment, the polyamide core-shell microcapsule comprises:
an oil based core comprising a hydrophobic active, preferably comprising 3-(2-isopropyl-4-methylphenyl)propanal or at least one of the invention's composition of matter, and
a polyamide shell comprising or being obtainable from:
   an acyl chloride,
   a first amino-compound being an amino-acid, preferably chosen from the group consisting of L-Lysine, L-Arginine, L-Histidine, L-Tryptophane and/or a mixture thereof.
   a second amino.compound chosen from the group consisting of ethylene diamine, diethylene triamine, cystamine and/or a mixture thereof, and
   a biopolymer chosen from the group consisting of casein, sodium caseinate, bovin serum albumin, whey protein, and/or a mixture thereof.

The first amino-compound can be different from the second amino-compound. Typically, a process for preparing a polyamide-based microcapsule includes the following steps:
a) dissolving at least one acyl chloride in a hydrophobic material, preferably a perfume to form an oil phase;
b) dispersing the oil phase obtained in step a) into a water phase comprising a first amino compound to form an oil-in water emulsion;
c) performing a curing step to form polyamide microcapsules in the form of a slurry; wherein a stabilizer is added in the oil phase and/or in the water phase, and wherein at least a second amino-compound is added in the water phase before the formation of the oil-in-water emulsion and/or in the oil-in water emulsion obtained after step b).

In a particular embodiment, the shell of the microcapsule is polyurea- or polyurethane-based. Examples of processes for the preparation of polyurea and polyurethane-based microcapsule slurries are for instance described in WO 2007/004166, EP 2300146, and EP 2579976. Typically a process for the preparation of polyurea or polyurethane-based microcapsule slurries include the following steps:
a) dissolving at least one polyisocyanate having at least two isocyanate groups in an oil to form an oil phase;
b) preparing an aqueous solution of an emulsifier or colloidal stabilizer to form a water phase;
c) adding the oil phase to the water phase to form an oil-in-water dispersion, wherein the mean droplet size is comprised between 1 and 500 μm, preferably between 5 and 50 μm; and
d) applying conditions sufficient to induce interfacial polymerization and form microcapsules in form of a slurry.

In a particular embodiment, the microcapsule can be in form of a powder, which in particular may be obtained by submitting the microcapsule slurry to a drying step, like spray-drying, to provide the microcapsules as such, i.e. in a powdery form. It is understood that any standard method known by a person skilled in the art to perform such drying is also applicable. In particular the slurry may be spray-dried, preferably in the presence of a polymeric carrier material such as polyvinyl acetate, polyvinyl alcohol, dextrins, natural or modified starch, gum Arabic, vegetable gums, pectins, xanthans, alginates, carrageenans or cellulose derivatives to provide microcapsules in a powder form.

However, one may also cite other drying methods such as extrusion, plating, spray granulation or fluidized bed processes, or even drying at room temperature using materials (carrier, desiccant) that meet specific criteria as disclosed in WO 2017/134179.

According to a particular embodiment, the compositions mentioned above, comprise more than one of the invention's composition of matter and enable the perfumer to prepare accords or perfumes possessing the odor tonality of various compositions of matter of the invention, creating thus new building block for creation purposes.

For the sake of clarity, it is also understood that any mixture resulting directly from a chemical synthesis, e.g. a reaction medium without an adequate purification, in which the compound or the compositions of matter of the invention would be involved as a starting, intermediate or end-product could not be considered as a perfuming composition according to the invention as far as said mixture does not provide the inventive compound or compositions of matter in a suitable form for perfumery. Thus, unpurified reaction mixtures are generally excluded from the present invention unless otherwise specified.

The invention's composition of matter or 3-(2-isopropyl-4-methylphenyl)propanal or 3-(5-isopropyl-2-methylphenyl)propanal can also be advantageously used in all the fields of modern perfumery, i.e. fine or functional perfumery, to positively impart or modify the odor of a consumer product into which 3-(2-isopropyl-4-methylphenyl)propanal or 3-(5-isopropyl-2-methylphenyl)propanal or said invention's composition of matter is added. Consequently, another object of the present invention consists of a perfumed consumer product comprising, as a perfuming ingredient, 3-(2-isopropyl-4-methylphenyl)propanal or 3-(5-isopropyl-2-methylphenyl)propanal or at least one of the invention's composition of matter, as defined above.

The invention's compound or the invention's composition of matter can be added as such or as part of an invention's perfuming composition.

For the sake of clarity, “perfumed consumer product” is meant to designate a consumer product which delivers at least a pleasant perfuming effect to the surface or space to which it is applied (e.g. skin, hair, textile, or home surface). In other words, a perfumed consumer product according to the invention is a perfumed consumer product which comprises a functional formulation, as well as optionally additional benefit agents, corresponding to the desired consumer product, and an olfactive effective amount of at least one invention's compound or the invention's composition of matter. For the sake of clarity, said perfumed consumer product is a non-edible product.

The nature and type of the constituents of the perfumed consumer product do not warrant a more detailed description here, which in any case would not be exhaustive, the skilled person being able to select them on the basis of his general knowledge and according to the nature and the desired effect of said product.

Non-limiting examples of suitable perfumed consumer products include a perfume, such as a fine perfume, a splash or eau de parfum, a cologne or a shave or after-shave lotion; a fabric care product, such as a liquid or solid detergent optionally in the form of a pod or tablet, a fabric softener, a liquid or solid scent booster, a dryer sheet, a fabric refresher, an ironing water, a paper, a bleach, a carpet cleaner, a curtain-care product; a body-care product, such as a hair care product (e.g. a shampoo, a leave-on or rinse-off hair conditioner, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner.

According to any embodiments of the invention, the perfumed consumer product of the invention are characterized by a pH of 1 or more. Particularly, the perfumed consumer product of the invention has a pH comprised between 1 and 12, or between 1 and 8. Even more particularly, the perfumed consumer product of the invention has a pH comprised between 1 and 6.

According to a particular embodiment, the invention's perfumed consumer product is in the form of a personal care, a home care or fabric care consumer product comprising ingredients that are common in the personal, home or fabric care consumer products, in particular shower gel, shampoo, soap, fabric detergents or softeners and all-purpose cleaners. The main functional constituents of perfumed consumer products are surfactants and/or softener components capable of cleaning and/or softening fabrics and/or textiles of varied nature, such as clothes, curtain fabrics, carpet and furniture fabrics, etc, or other home surfaces, skin or hair, and typically used in a large amount of water or water-based solvents. These are therefore formulations wherein the amount of water is typically comprised between 50 and 99% by weight of the perfumed consumer product with the exception of soap or solid detergent wherein the amount of water is at most 20%.

A more detailed description of such fabric cleaning and/or softening formulations is not warranted here, many descriptions of current liquid formulations can be found in the cleaner/fabric softener's patent and other pertinent literature, such as for example the textbook of Louis Ho Tan Tai, “Détergents et Produits de Soins Corporels, Chapters 1 to 7 in particular, Dunod, Paris, 1999, or any other similar and/or more recent textbooks pertaining to the art of liquid softener and all-purpose cleaners formulations. A patent publication, WO 2010/105873, is also cited by way of example, in as much as it describes typical current ingredients, other than perfumes, of such liquid products, particularly in pages 9 to 21. Of course, many other examples of liquid cleaner and/or fabric softener formulations can be found in the literature. Any such liquid formulations, namely liquid fabric cleaner or conditioner and/or all-purpose cleaner, can be used in the here-described compositions.

According to a particular embodiment of the invention, the invention's perfumed consumer product is a liquid fabric softener comprising a fabric softener active base in amount comprised between 85 and 100% by weight, based on the total weight of the perfumed consumer product. The main constituent of the fabric softener active base is water or water-based solvents. The fabric softener active base may comprise dialkyl quaternary ammonium salts, dialkyl ester quaternary ammonium salts, Hamburg esterquat, triethanolamine quat, silicones and mixtures thereof. Optionally, the fabric softener active base of the composition may further comprise a viscosity modifier in an amount comprised between 0.05 and 1% by weight, based on the total weight of the liquid base; preferably chosen in the group consisting of calcium chloride.

According to a particular embodiment of the invention, the invention's perfumed consumer product is an all-purpose cleaner comprising an all-purpose cleaner active base in amount comprised between 85 and 100% by weight, based on the total weight of the perfumed consumer product. The main constituent of the all-purpose cleaner active base is water or water-based solvents The all-purpose active base may comprise linear alkylbenzene sulfonates (LAS) in an amount comprised between 1 and 2%, nonionic surfactant in an amount comprised between 2 and 4% and acid such as citric acid in an amount comprised between 0.1 and 0.5%.

According to a particular embodiment of the invention, the invention's perfumed consumer product is a liquid detergent comprising a liquid detergent active base in amount comprised between 85 and 100% by weight, based on the total weight of the perfumed consumer product. The main constituent of the liquid detergent active base is water or water-based solvents. The liquid detergent active base may comprise anionic surfactant such as alkylbenzenesulfonate (ABS), linear alkylbenzene sulfonates (LAS), secondary alkyl sulfonate (SAS), primary alcohol sulfate (PAS), lauryl ether sulfate (LES), sodium lauryl ether sulfate (SLES), methyl ester sulfonate (MES); nonionic surfactant such as alkyl amines, alkanolamide, fatty alcohol poly(ethylene glycol) ether, fatty alcohol ethoxylate (FAE), ethylene oxide (EO) and propylene oxide (PO) copolymers, amine oxydes, alkyl polyglucosides, alkyl polyglucosamides; ormixtures thereof.

According to a particular embodiment of the invention, the invention's perfumed consumer product is a solid detergent comprising a solid detergent active base in amount comprised between 85 and 100% by weight, based on the total weight of the perfumed consumer product. The solid detergent active base may comprise at least one surfactant chosen in the group consisting of anionic, nonionic, cationic, zwiterionic surfactant and mixtures thereof. The surfactant in the solid detergent active base is preferably chosen in the group consisting of linear alkene benzene sulphonate (LABS), sodium laureth sulphate, sodium lauryl ether sulphate (SLES), sodium lauryl sulphate (SLS), alpha olefin sulphonate (AOS), methyl ester sulphonates (MES), alkyl polyglyucosides (APG), primary alcohol ethoxylates and in particular lauryl alcohol ethoxylates (LAE), primary alcohol sulphonates (PAS), soap and mixtures thereof. The solid detergent active base may comprise a further component, commonly used in powder detergent consumer product, selected from the group consisting of bleaching agents such as TAED (tetraacetylethylenediamine); buffering agent; builders such as zeolites, sodium carbonate or mixture thereof, soil release or soil suspension polymers; granulated enzyme particles such as cellulase, lipase, protease, mannanase, pectinase or mixtures thereof, corrosion inhibitor; antifoaming; sud suppressing agents; dyes; fillers such as sodium silicate, sodium sulfate or mixture thereof, source of hydrogen peroxide such as sodium percarbonate or sodium perborate; and mixtures thereof.

According to a particular embodiment of the invention, the invention's perfumed consumer product is shampoo or a shower gel comprising a shampoo or shower gel active base in amount comprised between 85 and 100% by weight, based on the total weight of the perfumed consumer product. The main constituent of the shampoo or a shower gel active base is water or water-based solvents The shampoo shower gel active base may comprise sodium alkylether sulfate, ammonium alkylether sulfates, alkylamphoacetate, cocamidopropyl betaine, cocamide MEA, alkylglucosides and aminoacid based surfactants.

According to a particular embodiment of the invention, the invention's perfumed consumer product is a soap bar comprising a soap active base in amount comprised between 85 and 100% by weight, based on the total weight of the perfumed consumer product. The soap bar active base may comprise salt of a weak acid, typically, a salt of weak acid, which may be a fatty acid and strong base like sodium hydroxide.

Some of the above-mentioned perfumed consumer products may represent an aggressive medium for the invention's compounds or the invention's compositions of matter, so that it may be necessary to protect the latter from premature decomposition, for example by encapsulation or by chemically binding it to another chemical which is suitable to release the invention's ingredient upon a suitable external stimulus, such as an enzyme, light, heat or a change of pH.

The proportions in which invention's compounds or the invention's compositions of matter according to the invention can be incorporated into the various aforementioned products or compositions vary within a wide range of values. These values are dependent on the nature of the article to be perfumed and on the desired organoleptic effect as well as on the nature of the co-ingredients in a given base when the compounds or the compositions of matter according to the invention are mixed with perfuming co-ingredients, solvents or additives commonly used in the art.

For example, in the case of perfuming compositions, typical concentrations are in the order of 0.001% to 20% by weight, or even more, of 3-(2-isopropyl-4-methylphenyl)propanal or 3-(5-isopropyl-2-methylphenyl)propanal or of the invention's composition of matter, based on the weight of the composition into which they are incorporated. In the case of perfumed consumer product, typical concentrations are in the order of 0.0001% to 10% by weight, or even more, of 3-(2-isopropyl-4-methylphenyl)propanal or 3-(5-isopropyl-2-methylphenyl)propanal or of the invention's composition of matter based on the weight of the consumer product into which they are incorporated.

Another object of the present invention is a method for arthropod control, preferably insect, which comprises bringing an arthropod, preferably insect, into direct contact or in contact with vapors of 3-(4-isopropyl-2-methylphenyl)propanal or 3-(2-isopropyl-4-methylphenyl)propanal or 3-(5-isopropyl-2-methylphenyl)propanal or the invention's composition of matter as defined above. In other words, the present invention is a method to confer, enhance, improve or modify the arthropod control properties of an arthropod control composition or of a arthropod control article, which method comprises adding to said composition or article an effective amount of at least 3-(2-isopropyl-4-methylphenyl)propanal or at least 3-(5-isopropyl-2-methylphenyl)propanal or at least one composition of matter as defined above

A further object of the present invention is use of 3-(4-isopropyl-2-methylphenyl)propanal or 3-(2-isopropyl-4-methylphenyl)propanal or 3-(5-isopropyl-2-methylphenyl)propanal or the invention's composition of matter as defined above to control arthropods, preferably insects.

The term “arthropod” has the normal meaning for a skilled person in the technical field. Arthropods include invertebrate animals, such as insects, arachnids, and crustaceans, that have a segmented body and jointed appendages. Arthropods usually have a chitinous exoskeleton molted at intervals, and a dorsal anterior brain connected to a ventral chain of ganglia.

Arthropods in the present invention's understanding relate to undesired arthropods, meaning that their presence in the air, on the surface of an article, the surface of a plant or the surface of a vertebrate, such as a human subject or other mammal, preferably human subject, is not desired. Preferably undesired arthropods are pest arthropods that impact plants and animals, e.g. thrips, aphids, beetles, moth, mealybug, scale etc., more preferably pest arthropods that impact animals, e.g. ants, termites, cockroaches, flies, etc., even more preferably blood feeding arthropods that impact vertebrates, e.g. biting fly, bed bug, kissing bug, flea, lice, mosquitoes and ticks, even more preferably mosquitos and ticks.

The reason why the presence of an arthropod is not desired might be that the arthropod's presence in the air is unpleasant to a subject, the contact of an arthropod on an article transfers diseases and/or germs or the arthropod bites an organism and causes itching, the transmission of diseases and/or germs or the arthropod feeding may be the cause for other diseases and/or conditions.

The expression “control”, “arthropod control” or the like has the normal meaning for a skilled person in the technical field. “Controlling” in the context of the present invention defines the ability of a compound or an arthropod controlling composition according to the present invention to attract, deter, kill or repel an arthropod, preferably deter or repel an arthropod and even more preferably repel an arthropod.

“Attracting” according to the present invention defines the ability of a compound or an arthropod attractant composition according to the invention to increase or encourage contact or the presence of an arthropod at the arthropod attractant source, such as in the air, on the surface of an article or on the surface of a vertebrate, such as a human subject or other mammal, preferably an article such as a trapping device, the arthropod attractant compound or composition has been applied to.
“Deterring” according to the present invention defines the ability of a compound or an arthropod deterrent composition according to the invention to minimize, reduce, discourage or prevent contact or the presence of an arthropod at the arthropod deterrent source, such as in the air, on the surface of an article or on the surface of an vertebrate, such as a human subject or other mammal, preferably human subject, to which the arthropod deterrent compound or composition has been applied to. Typically, the deterrent effect is shown when used as feeding deterrent hindering a pest from subsequent food intake or oviposition after an initial tasting of the arthropod deterrent compound or composition.
“Killing” according to the present invention defines the ability of a compound or an art report killing composition according to the present invention to kill an arthropod at the arthropod killing source, such as in the air, on the surface of an article or on the surface of a vertebrate, such as a human subject or other mammal, preferably human subject, to which the arthropod killing compound or composition has been applied to. When an arthropod killing composition is applied to a plant, an animal or human subject, it is applied in an amount which is killing to the arthropod but not to the subject.
“Repellency” according to the present invention defines the ability of a compound or an arthropod repellent composition according to the present invention to minimize, reduce, discourage or prevent approach or the presence of an arthropod at the arthropod repellent source, such as in the air, on the surface of an article or on the surface of an vertebrate, such as a human subject or other mammal, preferably human subject, to which the arthropod repellent compound or composition has been applied to.

Co-ingredients which are used in arthropod control formulation can be added to enhance the control efficacy. In particular one may cite ingredients chosen in the group consisting of ethyl 3-(acetyl(butyl)amino)propanoate (IR3535), N,N-diethyl-3-methylbenzamide (DEET), p-menthane-3,8-diol (PMD), Eucalyptus citriodora oil, Citronella spp. oil, sec-butyl 2-(2-hydroxyethyl)piperidine-1-carboxylate (picaridin), vanillin, Castor oil, Cedarwood oil, Cinnamon oil, Citronella, Citronella oil, Clove oil, Corn oil, Cornmint, Cornmint oil, Cottonseed oil, 4-Allyl-2-methoxyphenol (Eugenol), Garlic oil, (2E)-3,7-Dimethylocta-2,6-dien-1-ol (Geraniol), Geranium oil, Lemongrass oil, Linseed oil, Peppermint, Peppermint oil, 2-Phenylethyl propionate, Rosemary oil, Sesame oil, Soybean oil, Spearmint, Spearmint oil, Thyme oil, Mint, Mint oil, Pepper extract, Wintergreen oil, citronellal, Lavender oil, Lavandula hybrida extract, Lavandin oil, Lemon oil, Margosa extract, Mentha arvensis extract, Metofluthrin, Nonanoic acid, Pyrethrins and Pyrethroids, 2,3,4,5-bis(butyl-2-ene)tetrahydrofurfural (MGK Repellent 11), cineole, cinnamaldehyde, citral, citronellol, coumarin, dibutyl phthalate, diethyl phthalate, dimethyl anthranilate, dimethyl phthalate, ethyl anthranilate, ethyl vanillin, Eucalyptus oil, delta-octalactone, delta-nonalactone, delta-decalactone, delta-undecalactone, delta-dodecalactone, gamma-octalactone, gamma-nonalactone, gamma-decalactone, gamma-undecalactone, gamma-dodecalactone, hydroxycitronellal, Lime oil, limonene, linalool, methyl anthranilate, myrcene, Neem oil, Sabinene, β-Caryophyllene, (1H-indol-2-yl)acetic acid, anethole, anise oil, basil oil, bay oil, camphor, ethyl salicylate, evergreen oils, pine oil, Tetramethrin, Allethrin, (RS)-α-cyano-3phenoxybenzyl-(1RS)-cis, Cypermethrin, Prallethrin, Acetamiprid, Azadirachtin, Bendiocarb, Bifenthrin, Chlorpyrifos, Deltamethrin, Diazinon, Dichlorvos, fipronil, imidacloprid, Malathion, Margosa extract, Nicotine, Permethrin, Rotenone, S-Methoprene, Spinosad (Spinosyn A), Spinosyn D, Transfluthrin, anisic alcohol, octahydrocoumarin, (+-)-2,5-dimethyl-2-indanmethanol, 4,4A,5,9B-tetrahydro-indeno[1,2-D]-1,3-dioxin, 2,4-dimethyl-4,4a,5,9b-tetrahydroindeno[1,2-d][1,3]dioxine, and mixtures thereof.

The invention's compounds or the invention's compositions of matter can be prepared according to a method as described herein-below.

### EXAMPLES

The invention will now be described in further detail by way of the following examples, wherein the abbreviations have the usual meaning in the art, the temperatures are indicated in degrees centigrade (° C.). NMR spectra were acquired using either a Bruker Avance II Ultrashield 400 plus operating at 400 MHz, (¹H) and 100 MHz (¹³C) or a Bruker Avance 111500 operating at 500 MHz (¹H) and 125 MHz (¹³C) or a Bruker Avance III 600 cryoprobe operating at 600 MHz (¹H) and 150 MHz (¹³C). Spectra were internally referenced relative to tetramethyl silane 0.0 ppm. ¹H NMR signal shifts are expressed in δ ppm, coupling constants (J) are expressed in Hz with the following multiplicities: s, singlet; d, doublet; t, triplet; q, quartet; m, multiplet; b, broad (indicating unresolved couplings) and were interpreted using Bruker Topspin software. ¹³C NMR data are expressed in chemical shift δ ppm and hybridization from DEPT 90 and DEPT 135 experiments, C, quaternary; CH, methine; CH₂, methylene; CH₃, methyl.

### Example 1

### Synthesis of the Invention's Composition of Matter Comprising 3-(4-isopropyl-2-methylphenyl)propanal & 342-isopropyl-4-methylphenyl)propanal In a Ratio of 95:5

a) Step 1: Preparation of a Mixture Comprising 1-(diethoxymethyl)-4-isopropyl-2-methylbenzene & 1-(diethoxymethyl)-2-isopropyl-4-methylbenzene:

To the mixture of 4-isopropyl-2-methylbenzaldehyde & 2-isopropyl-4-methylbenzaldehyde (ratio 85/15; 400 g, 2465.6 mmol, 1 eq.) at 30° C. was added EtOH (168 mL) followed by p-toluenesulfonic acid (0.98 g, 5.18 mmol, 0.0021 eq.). Ethyl orthoformate (383.68 g, 2588.9 mmol, 1.05 eq.) was added over 2 hours. Exotherm (2° C.) was observed, and the mixture turned brown. 30 minutes after the end of the addition, sodium ethoxide (21% solution in methanol, 7.4 g, 28.77 mmol, 0.012 eq.) was added and the mixture was concentrated by distillation (Tmax=145° C., p=1000-20 mbar) (Tpot=120-145° C.; Tvap=61-75° C.). Lights were discarded.

The product was purified by flash distillation (Tpot=135° C.; Tvap=118° C.) to give 522.3 g of a mixture comprising 1-(diethoxymethyl)-4-isopropyl-2-methylbenzene & 1-(diethoxymethyl)-2-isopropyl-4-methylbenzene with a purity of 98%.

NMR data for the major isomer 1-(diethoxymethyl)-4-isopropyl-2-methylbenzene: ¹H NMR (400 MHz, DMSO): 7.34-7.36 (m, 1H), 7.02-7.03 (m, 2H), 5.49 (s, 1H), 3.43-3.49 (m, 4H), 2.79-2.85 (m, 1H), 2.29 (s, 3H), 1.18 (d, J=5.6 Hz, 6H), 1.12 (t, J=5.7 Hz, 6H). ¹³C NMR (125 MHz, DMSO): 15.1 (q), 18.6 (q), 23.8 (q), 33.1 (d), 60.9 (d), 99.7 (d), 122.9 (d), 126.0 (d), 128.3 (d), 134.4 (s), 135.6 (s), 148.0 (s).

b) Step 2: Preparation of a Mixture Comprising 4-isopropyl-2-methyl-1-(1,3,3-triethoxypropyl)benzene & 2-isopropyl-4-methyl-J-(1,3,3-triethoxypropyl)benzene

The mixture comprising 1-(diethoxymethyl)-4-isopropyl-2-methylbenzene & 1-(diethoxymethyl)-2-isopropyl-4-methylbenzene obtained in step 1 (80.0 g, 338.5 mmol, 0.2 eq) was charged under nitrogen in a 1.0 L Schmizo-type reactor. The mixture was cooled to 15° C. (set point pot). Boron trifluoride acetate (0.32 g, 1.7 mmol, 0.001 eq) was charged. The mixture turned deep red. A mixture of ethyl vinyl ether (124.5 g, 1726.3 mmol, 1.02 eq.) and 1-(diethoxymethyl)-4-isopropyl-2-methylbenzene & 1-(diethoxymethyl)-2-isopropyl-4-methylbenzene (320.0 g, 1353.9 mmol, 0.8 eq) was added in 5 hours. Exotherm (4° C.) was observed, and the colour of the mixture became lighter. 15 minutes after the end of the addition, sodium ethoxide (21% solution in ethanol, 4.1 g, 15.9 mmol, 0.01 eq.) was added. The mixture was stirred at 15° C. for 1 hour and then concentrated under reduced pressure (Tmax=125° C., p=200-10 mbar, Tvap=33° C.). The crude (514.0 g, 90% GC, brown liquid) was distilled through a 20 cm Widmer column after addition of Primol 352. (Tpot=150-160° C.; Tvap=72-117° C.; Pressure 0.8 to 0.42 mbar) gives 360.3 g of a mixture comprising 4-isopropyl-2-methyl-1-(1,3,3-triethoxypropyl)benzene & 2-isopropyl-4-methyl-1-(1,3,3-triethoxypropyl)benzene with a purity of 98%.

NMR data for the major isomer 1-(diethoxymethyl)-4-isopropyl-2-methylbenzene ¹H NMR (500 MHz, DMSO): 7.12-7.23 (m, 1H), 7.05-7.06 (m, 1H), 6.99-7.00 (m, 1H), 4.56 (dt, J=30 Hz, 4 Hz, 2H), 3.37-3.65 (m, 4H), 3.16-3.27 (m, 2H), 2.79-2.83 (m, 1H), 2.26 (s, 3H), 1.68-1.84 (m, 2H), 1.18 (d, J=6.9 Hz, 6H), 1.14 (t, J=7.1 Hz, 3H), 1.09 (t, J=6.9 Hz, 3H), 1.07 (t, J=6.9 Hz, 3H). ¹³C NMR (125 MHz, DMSO): 15.2 (q), 15.2 (q), 15.3 (q), 18.5 (q), 23.8 (q), 33.0 (d), 41.3 (t), 60.3 (t), 61.1 (t), 63.1 (t), 74.2 (d), 99.8 (d), 123.9 (d), 125.5 (d), 128.2 (d), 134.5 (s), 137.7 (s), 146.8 (s).

c) Step 3: Preparation of a Mixture Comprising (E)-3-(4-isopropyl-2-methylphenyl)acrylaldehyde & (E)-3-(2-isopropyl-4-methylphenyi)acrylaldehyde

The mixture comprising 4-isopropyl-2-methyl-1-(1,3,3-triethoxypropyl)benzene & 2-isopropyl-4-methyl-1-(1,3,3-triethoxypropyl)benzene obtained in step 2 (300.0 g, 972.57 mmol, 1.0 eq.) and acetic acid (321.2 g, 5349.2 mmol, 5.5 eq.) were charged under nitrogen in a 1.0 L Schmizo-type reactor. Sodium hydroxide (30% aqueous solution, 129.7 g, 972.57 mmol, 1.0 eq.) was charged under stirring. Exotherm: 30° C. The mixture was heated up to reflux during 6.5 hours (Tpot=103-91° C., Tvap=91-78° C.). The mixture turned yellow and then brown and became homogeneous. The mixture was cooled to 40° C. and the pressure lowered to 170 mbar. The mixture was concentrated by distillation (Tmax=60° C., ΔT=20° C. p=170-1 mbar). Distilled solvent was discarded. Water (675.0 g) and toluene (306 g) containing vitamin E (0.78 g) were added slowly keeping the temperature above 50° C. The mixture was cooled to 25° C. and allowed to settle. The aqueous phase was decanted and discarded. The organic phase was washed with 10% aqueous sodium carbonate (153 g) and demineralised water (54.0 g). The pressure was lowered to 150 mbar and the mixture was heated up to reflux (Tpot=70° C.) removing water azeotropically until no more water separated. The orange solution (175.2 g) was purified by a Flash distillation (Tpot=105-110° C.; Tvap=83-94° C.; Pressure 0.16 mbar) gives 134.4 g of a mixture comprising (E)-3-(4-isopropyl-2-methylphenyl)acrylaldehyde & (E)-3-(2-isopropyl-4-methylphenyl)acrylaldehyde with a purity of 90%.

NMR data for the major isomer (E)-3-(4-isopropyl-2-methylphenyl)acrylaldehyde ¹H NMR (500 MHz, CDCl₃): 9.70 (d, J=7.7 Hz, 1H), 7.75 (d, J=15.8 Hz, 1H), 7.54 (d, J=8 Hz, 1H), 7.10-7.13 (m, 2H), 6.64 (dd, J=15.8 Hz, 7.7 Hz, 1H), 2.87-2.92 (m, 1H), 2.47 (s, 3H), 2.26 (s, 3H), 1.68-1.84 (m, 2H), 1.18 (d, J=6.9 Hz, 6H), 1.25 (d, J=6.9 Hz, 6H). ¹³C NMR (125 MHz, CDCl₃): 19.9 (q), 23.7 (q), 34.1 (d), 124.8 (d), 127.0 (d), 128.7 (d), 129.3 (d), 130.4 (s), 138.1 (s), 150.4 (d), 152.5 (s), 194.0 (s).

d) Step 4: Preparation of the Invention's Composition of Matter Comprising 3-(4-isopropyl-2-methylphenyl)propanal & 3-(2-isopropyl-4-methylphenyl)propanal

An autoclave was charged with the mixture comprising (E)-3-(4-isopropyl-2-methylphenyl)acrylaldehyde and (E)-3-(2-isopropyl-4-methylphenyl)acrylaldehyde obtained in step 3 (15.0 g, 79.67 mmol, 1.0 eq.), Pd/C (5%, 50% w/w water, 0.05 g, 0.0003 eq.), AcOK (0.024 g, 0.239 mmol, 0.003 eq.) and IPrOH (30 g). After purging the autoclave and pressurized with 5 bar of hydrogen the mixture was heated at 70° C. during 30 h. The crude mixture was filtered and concentrated. The crude product was purified by a Flash distillation (Tpot=110° C.; Pressure 1.0 mbar) gives 11.0 g of the invention's composition of matter comprising 3-(4-isopropyl-2-methylphenyl)propanal & 3-(2-isopropyl-4-methylphenyl)propanal (ratio 95:5with a purity of 93%).

NMR data for the major isomer 3-(4-isopropyl-2-methylphenyl)propanal ¹H NMR (500 MHz, CDCl₃): 9.83 (t, J=1.5 Hz, 1H), 7.0-7.1 (m, 3H), 2.89-2.92 (m, 2H), 2.83-2.85 (m, 1H), 2.71-2.74 (m, 2H), 2.29 (s, 3H), 1.23 (d, J=7.0 Hz, 6H). ¹³C NMR (125 MHz, CDCl₃): 19.4 (q), 24.0 (q), 25.1 (t), 33.6 (d), 44.1 (t), 124.1 (d), 128.4 (d), 128.6 (d), 135.6 (s), 135.7 (s), 147.1 (s), 201.9 (d).

### Example 2

### Performance of Invention's Compounds as Arthropod Repellent

### a) Warm Body Assay: Small-Scale Test Used to Screen the Repellent Efficacy on Mosquitoes at Different Concentrations.

Aedes aegypti is a model organism for controlling tests and one of the recommended model organisms by the World Health Organization (WHO) as it is a very aggressive anthropophilic mosquito species that shows generally low sensitivity to arthropod controlling compounds. Anopheles gambiae is also a model organism as it is anthropophilic and transmits malaria.

The controlling effect according to the present invention was assessed using an adapted Warm Body assay as defined in Kröber T, Kessler S, FreiJ, Bourquin M, Guerin P M. 2010. J Am Mosq Control Assoc. 26:381-386. In this in-vitro assay the number of mosquito landing on a warm body, simulating an attractive host treated with the tested stimuli, was measured in order to assess the repellence effect.

The published protocol has been adapted as the switch from Anopheles gambiae to Aedes aegypti led to a decrease of mosquitoes placed in the tested cage due to the size difference (i.e. 30 mosquitoes instead of 50) and to an increase of lighting since Ae. aegypti is a diurnal mosquitoes (i.e. 150 lux instead of 4 lux).

On the sandblasted glass Petri dish covering the warm body (28.3 cm²), 100 μL of the compounds diluted at 5-8 concentrations in ethanol was applied. The number of mosquito landing on the warm body was counted for each stimulus and pure ethanol (solvent) as control.

The stimuli tested were stim A (3-(4-isopropyl-2-methylphenyl)propanal at 96%) and stim B (a composition of matter comprising 3-(4-isopropyl-2-methylphenyl)propanal, 3-(2-isopropyl-4-methylphenyl)propanal and 3-(2-methyl-5-propan-2-ylphenyl)propanal at 88%, 5% and 2%, respectively) diluted in ethanol. Five to eight concentrations were assessed on each stimulus, missing data points mentioned as n.d. The mean number of mosquito landings with the solvent only (0 mg/mL) is equal to 64.5±10.1 landings in two minutes.

As displayed in Table 1, the two stimuli displayed a relevant reduction of the number of mosquito landings due to concentration. This really demonstrates a biological repellent effect of the stimuli on mosquito behavior with >50% landing decrease as soon as 0.04% of any stimulus was applied on the Warm Body (Table 1).

TABLE 1
Percentage of repellence of mosquitoes Aedes aegypti landing on the
warm body baited with different stimuli at different concentrations.

| | 0.0032 | 0.016 | 0.0357 | 0.08 | 0.178 | 0.4 | 0.89 | 2 | 10 |
|---|---|---|---|---|---|---|---|---|---|
| | mg/mL | mg/mL | mg/mL | mg/mL | mg/mL | mg/mL | mg/mL | mg/mL | mg/mL |
| Stim A | 20% | 41% | n.d. | 40% | n.d. | 63% | n.d. | 71% | 90% |
| Stim B | 30% | 26% | 25% | n.d. | 34% | 61% | 70% | 53% | 68% |

### b) Warm Plate Assay: Small-Scale Test Used to Screen the Repellent Efficacy on Ticks at Different Concentrations.

Repellent efficacy of the different compounds was assessed against the sheep tick, Ixodes ricinus L that can transmit both bacterial and viral pathogens. I. ricinus is one of the recommended model organisms mentioned by the Guidance on the European Biological Products Regulation [Vol IL, Efficacy—Assessment & Evaluation (Parts B+C), v6.0, Août 2023]. Observations of repellent efficacy were made on last stage nymphs.

The repellent efficacy was assessed using the protocol of the in-vitro Warm Plate Assay as defined in Kröber T, Bourquin M, Guerin P M. 2013. Pestic. Biochem. Phys. 107(2):160-168.

Ticks had the choice of crossing a zone with 3-(4-isopropyl-2-methylphenyl)propanal (96%) applied or to stay on their refuge without any compound applied. To motivate ticks' movement, the warm plate was heated at 33° C. (to mimic vertebrate skin temperature) and hold in a favourable environment (23° C., 85% RH).

The stimulus tested was stim A (3-(4-isopropyl-2-methylphenyl)propanal at 96%) diluted in ethanol. Twelve different ticks were tested for each of the four concentrations.

As displayed in Table 2,3-(4-isopropyl-2-methylphenyl)propanal managed to repel the ticks Ixodes ricinus in a dose response manner. All ticks were repelled as soon as 0.02% of 3-(4-isopropyl-2-methylphenyl)propanal (96%) was applied on the warm plate (Table 2).

TABLE 2
Percentage of repellence of ticks Ixodes ricinus
on the warm plate baited with 3-(4-isopropyl-2-methylphenyl)propanal
at three different concentrations (n = 12).

| | 0 mg/mL | 0.4 mg/mL | 2 mg/mL | 10 mg/mL |
|---|---|---|---|---|
| Stim A | 0.0% | 25.0% | 100.0% | 100.0% |

1. A method to confer, enhance, improve or modify the odor properties of a perfuming composition or of a perfumed article, the method comprising adding to said composition or article an effective amount of a composition comprising 3-(4-isopropyl-2-methylphenyl)propanal and 3-(2-isopropyl-4-methylphenyl)propanal.

2. The method according to claim 1, wherein the composition comprises at least 75% w/w of 3-(4-isopropyl-2-methylphenyl)propanal, the percentage being relative to the total weight of the composition.

3. The method according to claim 1, wherein the composition comprises 75% to 99.5% w/w of 3-(4-isopropyl-2-methylphenyl)propanal and 0.5% to 25% w/w of 3-(2-isopropyl-4-methylphenyl)propanal, the percentage being relative to the total weight of the composition.

4. The method according to claim 1 wherein the composition comprises 80% to 99% w/w of 3-(4-isopropyl-2-methylphenyl)propanal and 1% to 20% w/w of 3-(2-isopropyl-4-methylphenyl)propanal, the percentage being relative to the total weight of the composition.

5. The method according to claim 1, wherein the composition further comprises at most 5% w/w of 3-(5-isopropyl-2-methylphenyl)propanal, the percentage being relative to the total weight of the composition.

6. (canceled)

7. A composition comprising 3-(4-isopropyl-2-methylphenyl)propanal and 3-(2-isopropyl-4-methylphenyl)propanal as defined in claim 1.

8. 3-(2-isopropyl-4-methylphenyl)propanal.

9. (canceled)

10. A method to confer, enhance, improve or modify the odor properties of a perfuming composition or of a perfumed article, the method comprising adding to said composition or article an effective amount of 3-(2-isopropyl-4-methylphenyl)propanal or 3-(5-isopropyl-2-methylphenyl)propanal.

11. A perfuming composition comprising
i) 3-(2-isopropyl-4-methylphenyl)propanal or 3-(5-isopropyl-2-methylphenyl)propanal or the composition as defined in claim 7;
ii) at least one ingredient selected from the group consisting of a perfumery carrier and a perfumery base; and
iii) optionally at least one perfumery adjuvant.

12. A perfumed consumer product comprising 3-(2-isopropyl-4-methylphenyl)propanal or 3-(5-isopropyl-2-methylphenyl)propanal or the composition as defined in claim 7.

13. The perfumed consumer product according to claim 12, wherein the perfumed consumer product is a perfume, a fabric care product, a body-care product, a cosmetic preparation, a skin-care product, an air care product, or a home care product.

14. The perfumed consumer product according to claim 13, wherein the perfumed consumer product is a fine perfume, a splash or eau de parfum, a cologne, a shave or after-shave lotion, a liquid or solid detergent optionally in the form of a pod or tablet, a fabric softener, a liquid or solid scent booster, a dryer sheet, a fabric refresher, an ironing water, a paper, a bleach, a carpet cleaner, a curtain-care product, a shampoo, a leave-on or rinse-off hair conditioner, a coloring preparation, a color-care product, a hair shaping product, a dental care product, a disinfectant, an intimate care product, a hair spray, a skin cream or lotion, a vanishing cream, a deodorant or antiperspirant, a hair remover, a tanning or sun or after sun product, a nail product, a skin cleansing, a makeup, a perfumed soap, a shower or bath mousse, oil or gel, a foot/hand care product, a hygiene product, an air freshener, a “ready to use” powdered air freshener, a mold remover, a furnisher care, a wipe, a dish detergent or hard-surface detergent, a leather care product, g a car care product.

15. A method of using a composition comprising 3-(4-isopropyl-2-methylphenyl)propanal or 3-(2-isopropyl-4-methylphenyl)propanal or 3-(5-isopropyl-2-methylphenyl)propanal or the composition as defined in claim 7, the method comprising using the composition to control arthropods.

16. The method of claim 15, wherein the arthropods are insects.

17. The method according to claim 1, wherein the composition comprises 85% to 95% w/w of 3-(4-isopropyl-2-methylphenyl)propanal and 3% to 15% w/w of 3-(2-isopropyl-4-methylphenyl)propanal, the percentage being relative to the total weight of the composition.

18. A perfumed consumer product comprising the perfuming composition as defined in claim 11.

19. The perfumed consumer product according to claim 18, wherein the perfumed consumer product is a perfume, a fabric care product, a body-care product, a cosmetic preparation, a skin-care product, an air care product, or a home care product.

20. The perfumed consumer product according to claim 18, wherein the perfumed consumer product is a fine perfume, a splash or eau de parfum, a cologne, a shave or after-shave lotion, a liquid or solid detergent optionally in the form of a pod or tablet, a fabric softener, a liquid or solid scent booster, a dryer sheet, a fabric refresher, an ironing water, a paper, a bleach, a carpet cleaner, a curtain-care product, a shampoo, a leave-on or rinse-off hair conditioner, a coloring preparation, a color-care product, a hair shaping product, a dental care product, a disinfectant, an intimate care product, a hair spray, a skin cream or lotion, a vanishing cream, a deodorant or antiperspirant, a hair remover, a tanning or sun or after sun product, a nail product, a skin cleansing, a makeup, a perfumed soap, a shower or bath mousse, oil or gel, a foot/hand care product, a hygiene product, an air freshener, a “ready to use” powdered air freshener, a mold remover, a furnisher care, a wipe, a dish detergent or hard-surface detergent, a leather care product, or a car care product.
